(19) United States
(12) Patent Application Publication
(10) Pub. No.: US 2008/0007748 A1
(43) Pub. Date: Jan. 10, 2008

(54) Compositing image data in a linear-light color space that preserves a desired look

(76) Inventors: Lars U. Borg, Saratoga, CA (US); Manish S. Kulkarni, Saratoga, CA (US)

Correspondence Address: FISH & RICHARDSON P.C., P.O. Box 1022, MINNEAPOLIS, MN, 55440-1022, US

(21) Appl. No.: 11/478,260

(22) Filed: Jun. 28, 2006

(51) Int. Cl. G06F 15/00

(52) U.S. Cl. 358/1.9; 358/518

(57) ABSTRACT

This specification describes technologies relating to compositing of image data. In general, one aspect of the subject matter described in this specification can be embodied in a method that includes generating color space transformations for respective imagery sources, wherein generating a color space transformation includes preparing first and second transforms for a given imagery source, wherein the first transform restores an original scene luminance in linear light, and the second transform adjusts chromaticities with respect to a target look color space. The method further includes obtaining at least two images corresponding to respective ones of the imagery sources; converting each of the at least two images to the target look color space using a corresponding one of the color space transformations; and compositing the converted at least two images into a single image in the target look color space.

### BACKGROUND

The present disclosure relates to compositing image data from multiple sources, such as adding visual effects to live footage. For example, in the motion picture industry, sources of image data can include live footage (e.g., captured on camera negative film and digitized in a scanner, or captured with digital motion picture cameras) and also simulated scenes or artwork created entirely by computer. Many visual effects operators prefer that image frames containing live action plates be edited and composited with other images in a linear-light color space.

In a linear-light color space, the code values are generally proportional to the luminance values measured in the real scene (typically the code values represent relative or absolute values of luminance, with gamma 1.0). The use of a linear-light color space for compositing can result in a more photo-realistic look, and can be useful for basic editing operations, such as adding a shadow or a blur, or changing the exposure by two stops. Visual effects software, such as Adobe® After Effects® 7.0 software, available from Adobe Systems Incorporated of San Jose, Calif., have added support for a linear-light color space (called the working space).

With an ICC (International Color Consortium) profile for the camera negative film, the film scanner values can be converted to a linear-light color space, there edited and composited with artwork from other sources, and converted back into the scanner color space for film-out. The ICC profile tries to reconstruct the relative luminance and colorimetry in the original scene from the scanned camera negative. Thus, an attempt is made to restore the original scene colorimetry, in addition to the original scene luminance, from a scanned negative film.

However, camera negative film is typically not colorimetric in that its spectral sensitivities often transform poorly into the CIE (Commission Internationale de L'Éclairage) color matching functions. The spectral sensitivities often do not meet the Luther condition (that the spectral sensitivities in color sensors employed by image input devices should be expressed by linear combinations of color matching functions or human cone sensitivities). For example, skin tones may appear warmer after capture. As a result, the original scene colorimetry often cannot be reconstructed accurately from the scanned camera negative, and it is a challenge to find a transform for restoring the scene colorimetry that results in no objectionable color errors.

An alternative approach is to convert the scanned values to what is referred to as “linearized transmittance obtained from density” using a formula, 10^{(-density/gamma)}, where gamma is measured for each film stock. This is a re-encoding of density values, which does not restore the scene's true luminance or its linear-light property. In addition, for RGB (Red Green Blue) chromaticities, one option is to make them fixed and independent of the output medium when re-encoding the density values as described above.

### SUMMARY

This specification describes technologies relating to compositing of image data. In general, one aspect of the subject matter described in this specification can be embodied in a method that includes generating color space transformations for respective imagery sources, wherein generating a color space transformation includes preparing first and second transforms for a given imagery source, wherein the first transform restores an original scene luminance in linear light, and the second transform adjusts chromaticities with respect to a target look color space. The method further includes obtaining at least two images corresponding to respective ones of the imagery sources; converting each of the at least two images to the target look color space using a corresponding one of the color space transformations; and compositing the converted at least two images into a single image in the target look color space. Other embodiments of this aspect include corresponding systems, apparatus, and computer program products.

These and other embodiments can optionally include one or more of the following features. The target look color space can include an RGB color space, an XYZ color space, or a color space including a linear combination of XYZ primaries. The method can further include converting the single image to an output color space (which can involve the inverse adjustment of the chromaticities); and sending the converted single image to a data store for output. Moreover, the method can further include generating a color space transformation for an output device, and converting the single image can include transforming the single image to a data encoding of the output device using the color space transformation generated for the output device.

Preparing the second transform can include preparing the second transform based on a target output appearance associated with theater projection. Preparing the second transform can include determining a matrix by extrapolating pastel colors in a theater color space to create oversaturated colors in the target look color space. Additionally, the given imagery source can include a live action video imagery source, and generating the color space transformations can include building a look profile from a nonlinear component of a scene profile and from a chromaticity component of a target output device profile.

Another aspect of the subject matter described in this specification can be embodied in a system that includes a user interface device; and one or more computers operable to interact with the user interface device and to composite video image data from multiple disparate sources in a linear-light color space that preserves a desired cinematographic look of the multiple disparate sources expressed as theater chromaticities. The one or more computers can be operable to convert the video image data from at least one of the multiple disparate sources to the linear-light color space using a matrix determined by extrapolating pastel colors in a theater color space to create oversaturated colors in the linear-light color space. The at least one of the multiple disparate sources can include a live action video imagery source. Additionally, the one or more computers can be operable to build a look profile, for converting image data to the linear-light color space, from a nonlinear component of a scene profile and from a chromaticity component of a target output device profile.

The one or more computers can include a server operable to interact with the user interface device through a data communication network, and the user interface device can be operable to interact with the server as a client. The user interface device can include a computer running a Web browser. Moreover, the one or more computers can include one personal computer, and the personal computer can include the user interface device.

Particular embodiments of the subject matter described in this specification can be implemented to realize one or more of the following advantages. Color spaces can be produced that are optimized for digitally adding visual effects to live footage. Such color spaces can be light-linear while retaining the cinematographic look. Thus, restoring the scene luminance can be combined with matching the look of the image data expressed as theater chromaticities.

The desired look for image data can be retained while also removing toes and shoulders in the color space (e.g., highlights in the image data can be uncompressed within the color space). RGB chromaticities can be adjusted within a linear-light color space to enable photo-realistic compositing and reduce color shift when moving image data between disparate media, such as HDTV (High Definition Television) and film projection, while also retaining the desired look of the image data. Hue shifts generated during compositing of image data can be reduced or eliminated altogether, and the differences between the color hues (based on the target look, e.g., the theater appearance) can be retained irrespective of the eventual output device.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example system configured to composite video data from multiple disparate sources in a linear-light color space that preserves a desired look of the multiple disparate sources.

FIG. 2 shows example source images and a composite image.

FIG. 3 is a flow chart showing an example process of compositing image data.

FIG. 4 shows an example RGB encoded color space.

FIG. 5 is a flow chart showing an example process of generating a target look color profile.

FIG. 6 shows example imagery sources and their transforms before compositing.

FIG. 7 shows an example of dynamic construction of a look profile.

### DETAILED DESCRIPTION

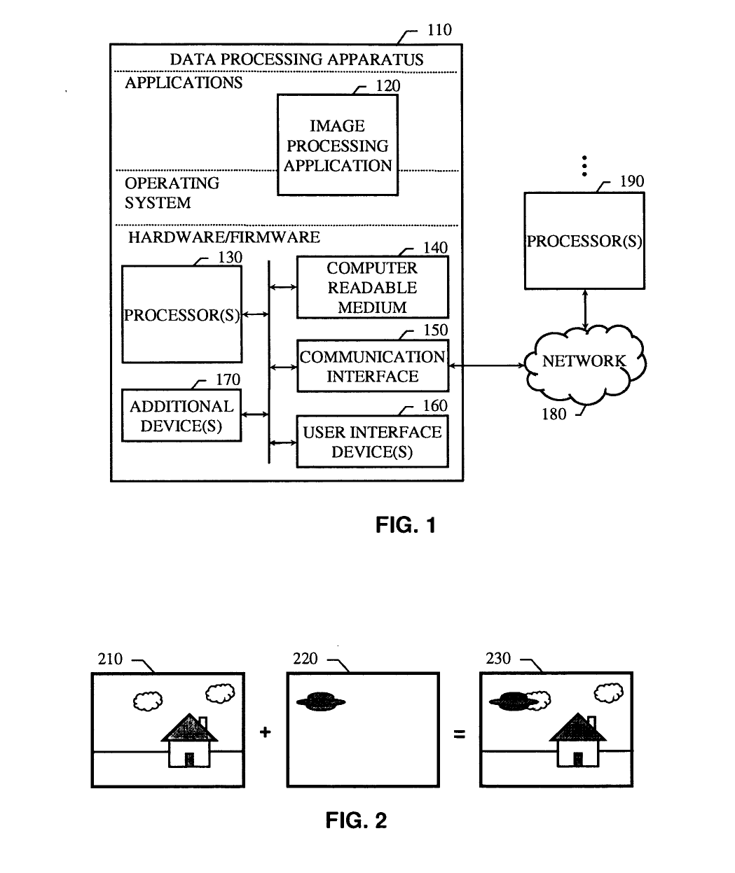

FIG. 1 shows an example system configured to composite video data from multiple disparate sources in a linear-light color space that preserves a desired look of the multiple disparate sources. A data processing apparatus 110 can include hardware/firmware, an operating system and one or more applications, including an image processing application 120. As used herein, an application refers to a computer program that the user perceives as a distinct computer tool used for a well-defined purpose. An application 120 can be built entirely into the operating system (OS) of the data processing apparatus 110, or an application 120 can have different components located in different locations (e.g., one portion in the OS or kernel mode, one portion in the user mode, and one portion in a remote server). Moreover, an application 120 can be a graphical user interface application (e.g., a Web browser) that connects to one or more processors 190 (e.g., one or more Web servers) over a network 180 and provides the computer tool as a network service.

The image processing application 120 can include visual effects software (e.g., Adobe® After Effects® software, available from Adobe Systems Incorporated of San Jose, Calif.), image editing software (e.g., Adobe® Photoshop® software, available from Adobe Systems Incorporated of San Jose, Calif.), and video editing software (e.g., Adobe® Premiere® software, available from Adobe Systems Incorporated of San Jose, Calif.). Thus, the image processing application 120 can operate on digital images from many different sources. Moreover, a digital image (which for brevity will simply be referred to as an image) does not necessarily correspond to a file. An image may be stored in a portion of a file that holds other images, in a single file dedicated to the image in question, or in multiple coordinated files.

The data processing apparatus 110 includes one or more processors 130 and at least one computer-readable medium 140. The data processing apparatus 110 can also include a communication interface 150, one or more user interface devices 160, and one or more additional devices 170. The user interface device(s) 160 can include display screen(s), keyboard(s) (e.g., a custom video editing keyboard), mouse, stylus, or any combination thereof. Moreover, the data processing apparatus 110 can itself be considered a user interface device (e.g., when the image processing application 120 is delivered as a Web service).

The additional device(s) 170 can include various devices used for video and film editing. This can include a video controller coupled to a video recorder (which can be used for storing and importing video footage and for writing final output), a sound system, and a battery backup. Moreover, the subject matter described in this specification can be used in conjunction with any digital print engine or marking engine, display monitor, or other raster output device capable of producing color or gray scale pixels on paper, film, display screen, or other output medium.

Once properly programmed, the data processing apparatus 110 is operable to composite (i.e., merge) image data from multiple disparate sources in a linear-light color space that preserves a desired look of the multiple disparate sources. The image data can include data from camera negative film, and the desired look can be the desired cinematographic look of the multiple disparate sources expressed as theater chromaticities. For example, the data processing apparatus 110 can be programmed to composite visual effects with live video footage, while retaining the theater appearance that the cinematographer would like to accomplish.

FIG. 2 shows example source images 210 & 220 and a composite image 230. The source image 210 can be from live footage, whereas the source image 220 can be a separately generated visual effect. For the source image 210, accurately restoring the scene colorimetry can undo the work of the cinematographer. The cinematographer often selects a particular film stock (e.g., Kodak versus Fuji) or film processing (e.g., normal versus bleach bypass) for its theatrical look. With a digital camera, the cinematographer can control numerous camera settings to determine the look, including changing the contrast or saturation of the captured scene.

The spectral sensitivities of a certain film stock contribute to the film's look. Accurately restoring the original scene colorimetry removes this look. When such a converted image is converted again, back to its original scanner color space using a transform that is a perfect inverse of the transform to the restored scene space, the image's original look gets restored.

However, the perfect inverse of the above transform doesn't retain the look when combining images from different sources, captured with different looks. As above, if compositing is done in the restored scene colorimetry, the look for all sources is removed. Subsequent transform to an output color space applies the look of the output color space to the data from all sources. This restores the original look only for the data that originated in the same color space as the output, while the original look is lost for the other image sources. The other image sources will get the look of the selected output space, likely somewhat distorted as the scene colorimetry can not, in general, be restored exactly.

In contrast, embodiments of the subject matter described in this specification can set the chromaticities of the RGB primaries in the compositing color space to create the colors of the desired look. Thus, the images 210 & 220 can be converted to a target look color space before compositing to form the composite image 230. In this target look color space, composited images retain the color appearance imposed by each capture device, thus retaining much of the look and the color differences between various capture devices or film stocks. In addition, the target look color space is a linear-light color space, and this linear-light property enables photo-realistic compositing.

For example, the image 210 can be data from scanned camera negative film. This data can be converted to a linear light encoding and then to the look colorimetry based on a target output device (e.g., a movie theater projector). The image 220 can be data from another capture device that is also converted to a linear light encoding and then to the look colorimetry based on the target output device. After compositing these images 210 & 220 in the target look color space, the composite image 230 can be converted to another color space, such as an output color space for a particular output device (e.g., digital motion picture projector, HDTV, mobile device Liquid Crystal Display (LCD)). This conversion is designed to retain the look, and thus, this transform may be the inverse of the input transforms.

Images from other data sources can be used in the compositing as well. Some data sources provide image data in direct scene colorimetry, in which the color palette is defined independent of a particular capture device. Some data sources have only a preferred look, but no scene colorimetry. For example, cartoons are usually created with the theater look. For example, all the frames of the movie Spirited Away were hand-painted, colored the way they should appear in the theater. Such additional data sources can also be used in the image compositing. Thus, image data from multiple disparate sources can be composited in a linear-light color space that preserves a desired cinematographic look of the multiple disparate sources expressed as theater chromaticities.

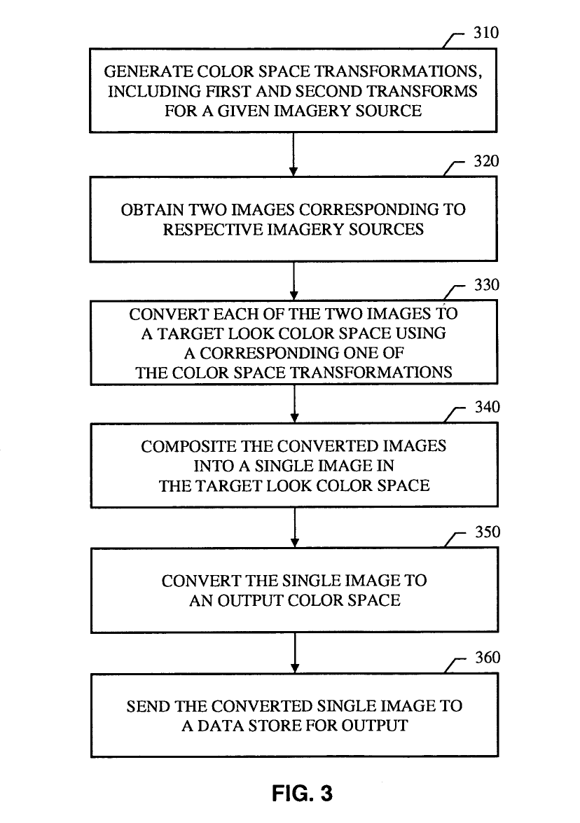

FIG. 3 is a flow chart showing an example process of compositing image data. Color space transformations are generated 310 for respective imagery sources (and also potentially for an output device). For at least one of the imagery sources, generating the color space transformation involves preparing first and second transforms, where the first transform restores an original scene luminance in linear light, and the second transform adjusts chromaticities with respect to a target look color space. Preparing the second transform can involve preparing the second transform based on a target output appearance associated with theater projection. Moreover, the color space transformations can include target look ICC profiles for respective capture devices, where a target look ICC profile contains two parts: one part providing the linear light property, and another part the chromaticity for the look.

For example, for scanner-encoded film data, applying the inverted characteristic curve(s) of the capture device to log-encoded RGB values restores the original scene luminance in linear light, per device source. This curve inverts not only the logarithmic characteristic of density, but also the toe and shoulder compressions. This is a known process in the image processing field and is used in Adobe® After Effects® 7.0 software, available from Adobe Systems Incorporated of San Jose, Calif. These curves should be specific for each unique capture device, film stock, or processing option. A separate curve for each color channel can be used, if available, although only one curve need be used in many cases. For example, the green channel curve may suffice even when the channels of a device have unique curves.

Similar methods can be used for other sources. For example, for HDTV, applying the inverse of the broadcast encoding specified in Recommendation ITU-R BT.709-5 can restore the original scene luminance in linear light. Some sources are direct measurements of scene colorimetry. These can be converted to scene CIE XYZ using standard formulas. CIE XYZ has linear-light properties.

The second part can involve calculating an approximate look in CIE XYZ colorimetry for each data source. This can be represented as an RGB to XYZ matrix for each data source, or look-up tables can be used instead. The matrix approach may be preferred in that the matrix should be fully invertible. The matrix can define a linear-light RGB space for the device. The look is the theater appearance that the cinematographer desires. The xy chromaticities of the RGB primaries can be set to retain the theater colors, and the RGB to XYZ matrix can be calculated to closely match selected colors. The selected colors can be a small set of training colors projected in the cinema theater, or virtually projected using techniques for previewing digital motion picture content, such as is described in U.S. patent application Ser. No. 11/351,757, to Lars U. Borg, filed Feb. 10, 2006, and entitled “METHOD AND APPARATUS FOR PREVIEWING DIGITAL MOTION PICTURE CONTENT”, or such as is described in U.S. patent applicatin Ser. No. 11/056,626, to Manish S. Kulkami et al., filed Feb. 11, 2005, and entitled “MOTION PICTURE CONTENT PREVIEW”, both of which are hereby incorporated by reference.

One challenge is that the print film used for theater projection often causes a strong increase in the image contrast. This in turn can cause hue shifts for most colors in the gamut. The contrast-induced change in ratio between channel values is often a major cause of hue shifts in the center of the gamut. The matrix calculation can thus be based on training colors with a modest hue shift. In some implementations, the training colors are selected around mid-gray with the same luminance as mid-gray and with the chromaticity at 20-40% of max chromaticity. Only the core of the gamut need be sampled, to avoid nonlinear effects towards the edge of the gamut. For HDTV sources, the look colorimetry can be calculated using the sRGB color space, which approximates the TV appearance.

At least two images corresponding to respective ones of the imagery sources can be obtained 320. Individual images can be acquired or received, or whole sets of images (e.g., video data) can be acquired or received altogether. Each of the at least two images can be converted 330 to the target look color space using a corresponding one of the color space transformations. For example, images to be composited can be converted to the CIE XYZ colorimetry of the desired look using the target look ICC profile of each image's respective source device, and the images to be composited can also be converted to the linear-light RGB space that is defined by the target look ICC profile of the output device (e.g., by applying the inverse of the profile's RGB to XYZ matrix).

The converted at least two images can then be composited 340 into a single image in the target look color space. Note that the target look color space can also be a linear-light RGB space with extended gamuts (e.g., the data can be converted from XYZ to RGB, since many compositors prefer to work in RGB over XYZ; for example, compositors are used to RGB color pickers). This compositing can involve additional features and operations, such as composting using various transparency effects, as is understood in the field. The single image can be converted 350 to an output color space, such as by applying the inverse of the remaining part of the output device's target look ICC profile, transforming values from the device's linear-light RGB space back to output device encodings. For example, for film image data, the characteristic curve can be applied.

In addition, it should be noted that rather than conversion to a specific output device color space, a conversion to an intermediate color space (or the color space of one of the image source devices) can be performed, and such color spaces can be used to transfer the composited image data to other locations for eventual output to a specific output device. Thus, the converted single image can be sent 360 to a data store for output (either for immediate output or for output at a later time). For example, the converted single image can be stored for a predetermined or indefinite length of time before being sent to an output device (e.g., a digital motion picture theater projector, HDTV, monitor, printer, mobile phone). The converted single image can be stored, for example, in a computer system, a memory device, or other data storage apparatus.

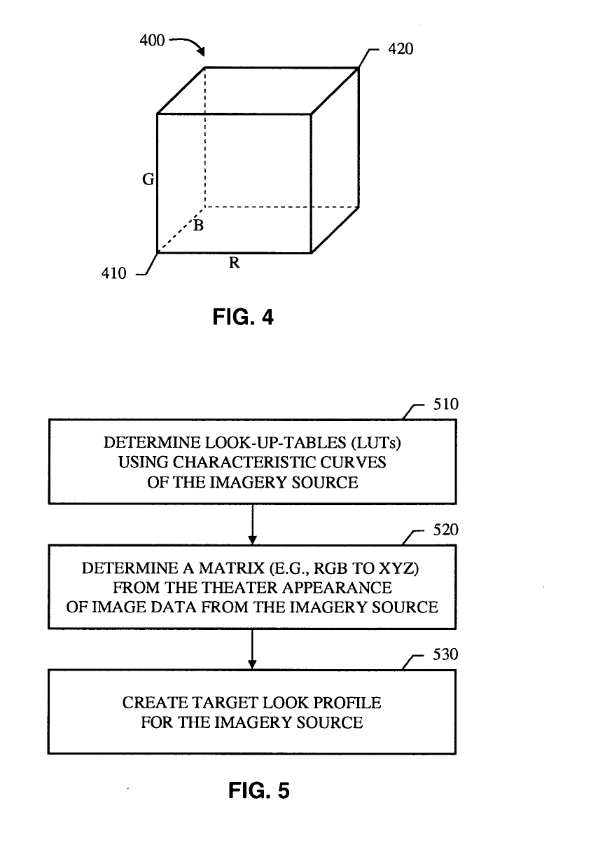

FIG. 4 shows an example RGB encoded target look color space 400. The target look color space 400 represents a virtual RGB-encoded scene in which light behaves linearly. Thus, the RGB code values (going from an origin 410 to nominal white at R=G=B=maximum 420) are generally proportional to the luminance values measured in the real scene, but the distance between different hues in the color space 400 corresponds to the desired look (e.g., the theater appearance of the image data). The chromaticities of the RGB primaries in the look space are set to create the colors of the desired look, and captured images are transformed to this target look color space before compositing. Thus, if two different capture devices cause different real-world colors to result in the same color in the target look (e.g., the same color in the theater), then the different real-world colors are composited in a space in which they are treated as the same color. Likewise, if two different capture devices cause the same real-world color to result in different colors in the target look (e.g., different colors in the theater), then the same color captured by the different devices is composited in a space in which that color is treated as two distinct colors (depending on the capture device source).

In target look color space 400, composited images retain the color appearance imposed by respective capture devices, thus retaining much of the look and the color differences between various capture devices or film stocks. The linear-light property removes the nonlinearity introduced by various imagery sources and enables photo-realistic compositing, while the conversion to a common colorimetry allows any desired color shifts (the look effect) created by the imagery source (e.g., the film stock selected for image acquisition) to be preserved.

FIG. 5 is a flow chart showing an example process of generating a target look color profile. Look-up-tables (LUTs) can be determined 510 using the characteristic curves of the imagery source. A characteristic curve represents a response of the imagery source (e.g., scanned film data) to light exposure. For an ICC profile, three identical one dimensional LUTs can be determined using the characteristic curves (e.g., the characteristic curves of Kodak 5218 film). The DPX (Digital Picture Exchange) Printing Density (PD) Range [0, 2.046] can be converted to Status M using the following linear relationship: StM=0.6144+0.9355*PD. The resulting Status M range [0.6144, 2.5284] can be converted to Log Exposure using the characteristic curve. The Log Exposure can be converted to Linear Exposure using: Linear_Value=10^{(-Log}^{_{—}}_{Value)}. Finally, the curve can be scaled so that DPX 470 (in a 10-bit Range [0,1023]) maps to 18% gray.

A matrix can be determined 520 from the theater appearance of image data from the imagery source. The matrix can be a matrix used to convert RGB to XYZ data. As discussed above, the matrix calculation can be based on selected colors with a small hue shift. The hue shift is smallest for colors with channel value ratios of 0 or 1. The colors used can be pure red, green, blue, cyan, magenta, and yellow, as the values for each channel are either 0 or x, with x being same for all channels. The x value should be within the linear portion of the dynamic range. Several x values should be used. The process for calculating the matrix from these values is similar to the process described above for restoring the original scene colorimetry.

Using either a model or measurements, the xy chromaticities in theater appearance can be determined for DPX values corresponding to four colors: red, green, blue and mid (LAD) gray. Note that use of partially saturated red, green, and blue, instead of fully saturated red, green, and blue, can result in improved accuracy in the core of the gamut. Doing the matrix calculation can involve extrapolating pastel colors in theater space, and since such pastel colors are less impacted by contrast functions, the extrapolation of these pastel colors can result in highly saturated colors in the target look (compositing) color space (that is, oversaturated colors compared to the theater, which fosters device independence for the eventual data conversion and output). For example, four training colors can be used: grey, pastel red, pastel green, and pastel blue. Using xy chromaticities, a 3×3 RGB to XYZ matrix can be calculated, and this matrix can then be adapted chromatically from the chromaticity of device grey to the ICC D50 white point.

When using measurements for determining the xy chromaticities in theater appearance, these measurements can come directly from samples taken in an actual theater, where theater CIE XYZ values can be measured for specified DPX RGB values. When using a model, the model should be able to predict theater appearance in CIE XYZ from DPX RGB values. For example, the model and process used can be that described in U.S. patent application Ser. No. 11/351,757, to Lars U. Borg, or that described in U.S. patent application Ser. No. 11/056,626, to Manish S. Kulkami et al. Note that the colorimetry of the look space need not be identical to the colorimetry of the actual theater, provided the colorimetry of the look space is consistent between different imagery sources.

With the matrix and LUTs, a target look profile can be created 530 for the imagery source. For a V4 ICC profile, the A2B0 tag can be created by scaling the ID LUTs (which range from approximately 0.00185 to 75.83) so that the Max Value is 1, giving the approximate range, [2.4459e-5, 1]. The curve has a very small slope in the beginning, and as a result, the curve cannot be encoded as-is in an ICC profile that has only 16-bit precision. To address this issue, the curve can be split into two, where the first curve is the original curve to the power 0.5, and the second curve is a gamma function with exponent 2.0. Raising the original curve to a power of 0.5 decreases the slope sufficiently so that the curve can be accurately encoded in an ICC profile that has only 16-bit precision.

The matrix can be encoded as-is. Thus, the overall A2B0 tag includes: (1) A Curves: Scene Curve, with gamma 0.5; (2) CLUT: Identity; (3) M Curves: Parametric Curve, gamma 2.0 (which is 1/0.5); (4) Matrix: Scene Matrix; and (5) B Curves: Identity. For the B2A0 tag in a V4 ICC profile, the process can be inverted: (1) B Curves: Identity; (2) Matrix: Inverse of Scene Matrix; (3) M Curves: Parametric Curve, gamma 0.5 (which is 1/2.0); (4) CLUT: Identity; (5) A Curves: Inverse of Scene Curve, with gamma 2.0.

Note that two curves can be used in the B2A0 tag to prevent extremely high interpolation errors in the dark regions of the curve. Using a gamma of 2.0 with the Inverse Scene Curve is of particular interest here, because the M-curve can then be implemented using a square root operation, which is generally faster than a general power function implementation. Thus using a gamma of 2.0 with the Inverse Scene Curve is generally faster than using a different gamma, such as 4.0. The Media White Point in the profile can be set to be 75.83 (max value of un-scaled Scene Curve) times D50. The reason for doing this is that when Absolute Colorimetric rendering intent is used, the Color Management Engine does the correct scaling of the Scene Curve to the full DPX range. This helps to ensure that the entire DPX Range can be encoded in ICC profiles that otherwise do not support over-range data.

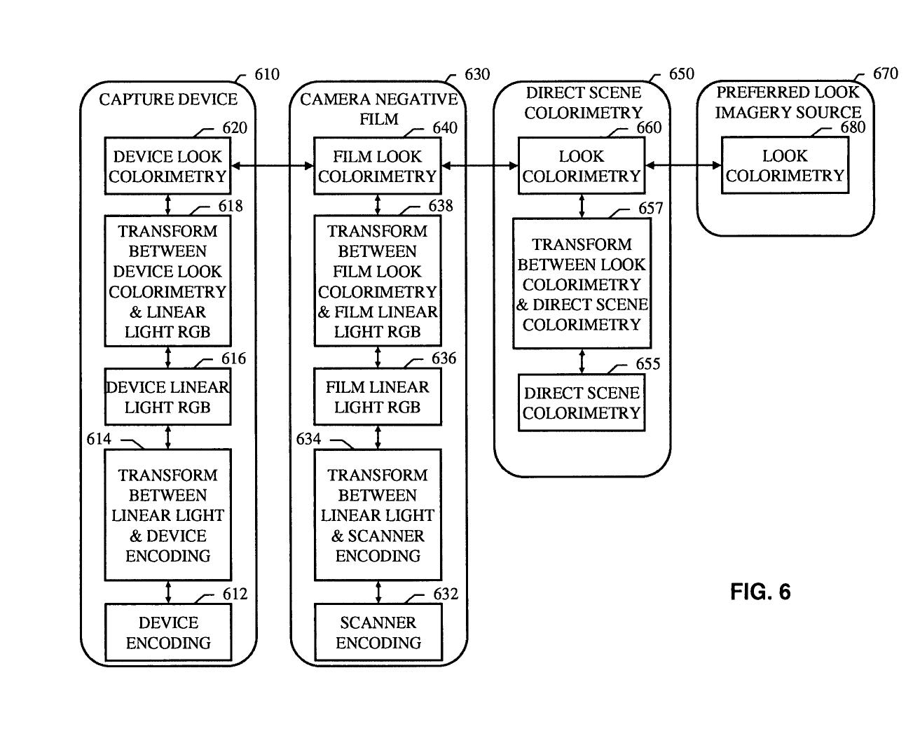

FIG. 6 shows example imagery sources and their transforms before compositing. A capture device 610 (e.g., a digital motion picture camera) provides image data in a device encoding 612. A first transform 614 can convert between the device encoding 612 and device linear light RGB 616, and a second transform 618 can convert between the device linear light RGB 616 and device look colorimetry 620, which lies in the look color space. For camera negative film 630, image data is provided in a scanner encoding 632. A first transform 634 can convert between the scanner encoding 632 and film linear light RGB 636, and a second transform 638 can convert between the film linear light RGB 636 and film look colorimetry 640, which lies in the look color space.

A direct scene colorimetry source 650 provides image data with a direct scene colorimetry 655, where the color palette is defined independent of a particular capture device. An example of such data is a High Dynamic Range (HDR) image that is generated from multiple images captured by a camera at various exposure levels (e.g., the camera captures three images at exposure levels E0, E1, E2; these three images are converted to Scene Colorimetry, and then composited in Scene Colorimetry to result in a single HDR image). The resultant HDR image can be considered a direct scene colorimetry image for further compositing with other sources such as film images and camera images.

A transform 657 can convert between the direct scene colorimetry 655 and look colorimetry 660, which lies in the look color space. A preferred look imagery source 670 provides data in look colorimetry 680, which already lies in the look color space. An example of this type of imagery source would be hand painted animation, where the colors have been selected to result in the preferred theater appearance after being digitally scanned. For all these imagery sources, the look color space is the linear light color space in which compositing of image data from the multiple disparate imagery sources 610, 630, 650, and 670 is performed. The resulting composited data can then be converted to another color space (e.g., for output or storage) as desired.

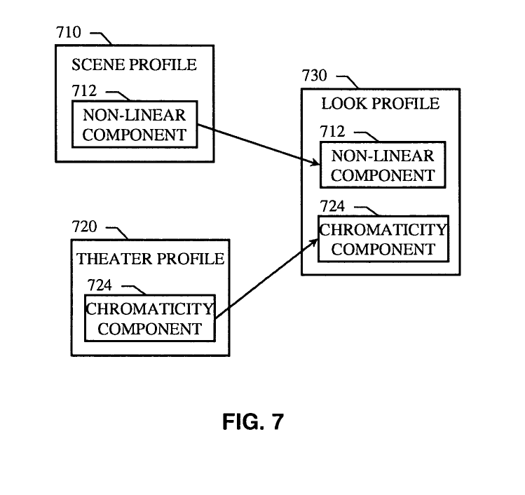

As discussed above, the first and second transforms for a given imagery source can be combined in a single look profile for that imagery source, where the look profile can be used to convert image data between the source color space and the look color space for compositing. Look profiles for specific imagery sources can be determined well in advance of compositing, or the look profiles can be created on the fly, as needed. FIG. 7 shows an example of dynamic construction of a look profile 730.

In this example, a scene profile 710 is already available for the imagery source. The scene profile 710 converts between the source color space and a reconstructed original scene color space (in linear light). The scene profile 710 includes a nonlinear component 712 that effects the conversion to linear light. Additionally, a theater profile 720 is already available for the imagery source (e.g., such a profile can be available for motion picture content previewing). The theater profile 720 converts between the source color space and the theater color space. The theater profile 720 includes a chromaticity component 724 that affects the chromaticity of the image data.

The look profile 730 can be built using the nonlinear component 712 from the scene profile 710 and the chromaticity component 724 from the theater profile 720. Thus, a look profile can be generated dynamically for an imagery source from other profiles.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results. Moreover, the target look color space can be selected from various color space types. Source image data can be converted to a shared look RGB space, either directly, or by first converting to look XYZ and then from look XYZ to RGB (e.g., using a shared matrix) for compositing. In addition to CIE XYZ, other color spaces that are linear combinations of the XYZ primaries can also be used.

What is claimed is:

1. A method comprising:
generating color space transformations for respective imagery sources, wherein generating a color space transformation comprises preparing first and second transforms for a given imagery source, wherein the first transform restores an original scene luminance in linear light, and the second transform adjusts chromaticities with respect to a target look color space;
obtaining at least two images corresponding to respective ones of the imagery sources;
converting each of the at least two images to the target look color space using a corresponding one of the color space transformations; and
compositing the converted at least two images into a single image in the target look color space.

2. The method of claim 1, wherein the target look color space comprises an RGB color space, an XYZ color space, or a color space comprising a linear combination of XYZ primaries.

3. The method of claim 1, further comprising:
converting the single image to an output color space; and
sending the converted single image to a data store for output.

4. The method of claim 3, further comprising generating a color space transformation for an output device, wherein converting the single image comprises transforming the single image to a data encoding of the output device using the color space transformation generated for the output device.

5. The method of claim 1, wherein preparing the second transform comprises preparing the second transform based on a target output appearance associated with theater projection.

6. The method of claim 5, wherein preparing the second transform comprises determining a matrix by extrapolating pastel colors in a theater color space to create oversaturated colors in the target look color space.

7. The method of claim 5, wherein the given imagery source comprises a live action video imagery source.

8. The method of claim 1, wherein generating the color space transformations comprises building a look profile from a nonlinear component of a scene profile and from a chromaticity component of a target output device profile.

9. A computer program product, encoded on a computer-readable medium, operable to cause data processing apparatus to perform operations comprising:
generating color space transformations for respective imagery sources, wherein generating a color space transformation comprises preparing first and second transforms for a given imagery source, wherein the first transform restores an original scene luminance in linear light, and the second transform adjusts chromaticities with respect to a target look color space;
obtaining at least two images corresponding to respective ones of the imagery sources;
converting each of the at least two images to the target look color space using a corresponding one of the color space transformations; and
compositing the converted at least two images into a single image in the target look color space.

10. The computer program product of claim 9, wherein the target look color space comprises an RGB color space, an XYZ color space, or a color space comprising a linear combination of XYZ primaries.

11. The computer program product of claim 9, wherein the operations further comprise:
converting the single image to an output color space; and
sending the converted single image to a data store for output.

12. The computer program product of claim 11, wherein the operations further comprise generating a color space transformation for an output device, and wherein converting the single image comprises transforming the single image to a data encoding of the output device using the color space transformation generated for the output device.

13. The computer program product of claim 9, wherein preparing the second transform comprises preparing the second transform based on a target output appearance associated with theater projection.

14. The computer program product of claim 13, wherein preparing the second transform comprises determining a matrix by extrapolating pastel colors in a theater color space to create oversaturated colors in the target look color space.

15. The computer program product of claim 13, wherein the given imagery source comprises a live action video imagery source.

16. The computer program product of claim 9, wherein generating the color space transformations comprises building a look profile from a nonlinear component of a scene profile and from a chromaticity component of a target output device profile.

17. A system comprising:
a user interface device; and
one or more computers operable to interact with the user interface device and to composite video image data from multiple disparate sources in a linear-light color space that preserves a desired cinematographic look of the multiple disparate sources expressed as theater chromaticities.

18. The system of claim 17, the one or more computers operable to convert the video image data from at least one of the multiple disparate sources to the linear-light color space using a matrix determined by extrapolating pastel colors in a theater color space to create oversaturated colors in the linear-light color space.

19. The system of claim 18, wherein the at least one of the multiple disparate sources comprises a live action video imagery source.

20. The system of claim 17, the one or more computers operable to build a look profile, for converting image data to the linear-light color space, from a nonlinear component of a scene profile and from a chromaticity component of a target output device profile.

21. The system of claim 17, wherein the one or more computers comprise a server operable to interact with the user interface device through a data communication network, and the user interface device is operable to interact with the server as a client.

22. The system of claim 21, wherein the user interface device comprises a computer running a Web browser.

23. The system of claim 17, wherein the one or more computers comprises one personal computer, and the personal computer comprises the user interface device.
